(19) United States
(12) Patent Application Publication
(10) Pub. No.: US 2026/0295944 A1
(43) Pub. Date: Oct. 1, 2026

(54) DYNAMICALLY GENERATING 3D PRINTABLE FORM FACTOR STORAGE UNITS

(71) Applicant: INTERNATIONAL BUSINESS MACHINES CORPORATION, Armonk, NY (US)

(72) Inventors: Zachary Augustus Silverstein, Georgetown, TX (US); Logan Bailey, Atlanta, GA (US); Melanie Bendix, Oceanside, NY (US); Jacob Ryan Jepperson, St. Paul, MN (US); Jeremy R. Fox, Georgetown, TX (US)

(21) Appl. No.: 19/093,666

(22) Filed: Mar. 28, 2025

(51) Int. Cl. B29C 64/386; G06T 7/521; G06T 17/00; B33Y 50/00

(52) U.S. Cl. CPC B29C 64/386; G06T 7/521; G06T 17/00; B33Y 50/00

(57) ABSTRACT

A method, system, and computer program product configured to perform operations including: receiving input data comprising visual scan data of a workspace and object information associated with an object to be stored in the workspace; generating specification data based on the input data; and creating a three-dimensional (3D) printable blueprint of a storage unit based on the specification data.

### BACKGROUND

Aspects of the present invention relate generally to three-dimensional (3D) printing and object storage.

3D printing is a technology that is used to construct a three-dimensional object (3D object) from a digital model. 3D printing is performed in processes in which material is deposited and joined or solidified under computer control, with material typically being added together layer by layer.

### SUMMARY

In a first aspect of the invention, there is a method including: receiving input data comprising visual scan data of a workspace and object information associated with an object to be stored in the workspace; generating specification data based on the input data; and creating a three-dimensional (3D) printable blueprint of a storage unit based on the specification data.

In another aspect of the invention, there is a computer program product comprising one or more computer-readable storage media and program instructions stored on the one or more computer-readable storage media to perform operations comprising: receiving input data comprising visual scan data of a workspace and object information associated with an object to be stored in the workspace; generating specification data based on the input data; and creating a three-dimensional (3D) printable blueprint of a storage unit based on the specification data, wherein the 3D printable blueprint comprises a digital representation of the storage unit that is usable by a 3D printer to manufacture the storage unit using additive manufacturing

In another aspect of the invention, there is a computer system comprising a processor set, one or more computer-readable storage media, and program instructions stored on the one or more computer-readable storage media to cause the processor set to perform operations comprising: receiving input data comprising visual scan data of a workspace and object information associated with an object to be stored in the workspace; generating specification data based on the input data; and creating a three-dimensional (3D) printable blueprint of a storage unit based on the specification data, wherein the 3D printable blueprint comprises a digital representation of the storage unit that is usable by a 3D printer to manufacture the storage unit using additive manufacturing, and wherein the storage unit is customized to fit within the workspace and to hold the object.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to 3D printing and object storage and, more particularly, to dynamically generating 3D printable form factor storage units. Implementations of the invention provide for dynamically generating a 3D printable blueprint of a 3D printable storage unit based on a combination of analyzing a visual scan of a workspace intended for the storage unit and details about one or more objects intended to be stored in the storage unit. Embodiments described herein enable a user to obtain, on demand, a 3D printable blueprint of a 3D printable storage unit that is customized to both the workspace that will hold the storage unit and the object that will be stored in the storage unit by visually scanning the workspace (e.g., with their mobile device) and providing details about the object.

Prefabricated storage units often do not perfectly fit both the space in which the storage units are used and the objects that are stored within the storage units. For example, a prefabricated plastic storage bin that a user purchases for utilizing in a space in their home might not fit perfectly in the space. The bin might not fill the entire space, and the unfilled portion of the space might be of a size and shape that is essentially unusable for much else. The bin might also be too large for the space in one dimension, such that a portion of the bin sticks outward from the space in an unsightly manner, for example. Moreover, the bin might not be a perfect fit for the object that the user intends to store in the bin. A simple example is storing a spherical object in a rectangular bin, which results in wasted space inside the bin. These problems often leave users dealing with inefficient usages of space in their homes, places of work, and other places. These problems also cause some users to spend vast amounts of time and effort searching for prefabricated storage units that are a ‘good enough’ fit for their space and objects.

Implementations of the present invention provide a solution to these problems by enabling a user to obtain a 3D printable blueprint of a 3D printable storage unit that is customized to both the workspace that will hold the storage unit and the object that will be stored in the storage unit. In embodiments, a user visually scans the workspace where the object will be stored (e.g., with their mobile device) and provides the visual scan and details about the object to a modeling tool. In embodiments, using the visual scan of the workspace and details about the object to be stored, the modeling tool uses one or more artificial intelligence (AI) models to dynamically generate a 3D printable blueprint of a 3D printable storage unit that is customized for both the workspace and the object. The customized size and shape of the exterior of the storage unit ensures an optimal fit of the storage unit in the workspace scanned by the user. The customized size and shape of the interior of the storage unit ensures an optimal fit of the object inside the storage unit. The user may then utilize the 3D printable blueprint with a 3D printer to print (e.g., manufacture) the 3D printable storage unit. In this manner, the user may obtain a customized storage unit, on demand, that is an optimal fit for both the workspace to be used for storage and the object to be stored. These benefits provided by implementations of the invention constitute an improvement in the technology of 3D printing and the technical area of object storage.

In various aspects of the invention, a method, system, and computer program product are configured to perform operations specially adapted for utilizing space and storage analysis to programmatically generate dynamic printed storage. In various embodiments, the operations comprise: ingesting a workspace defined by a visual scan; identifying one or more storage goods to be stored in the workspace; generating a 3D printable blueprint based on storing the one or more storage goods in the workspace; and 3D printing a storage unit based on the 3D printable blueprint. In some embodiments, the visual scan is aided by a manual demarcation of a user. In some embodiments, the identifying one or more storage goods in the workspace further comprises ingesting metadata including a weight, a tolerance, and a resilience of the one or more storage goods. In some embodiments, the operations further comprise: recommending an orientation of the one or more storage goods in the 3D printed storage unit; and recommending a relocation of the one or more storage goods to optimize a size of the 3D printed storage unit.

Implementations of the invention are necessarily rooted in computer technology. For example, the step of creating a 3D printable blueprint using an AI model (e.g., a trained generative adversarial network (GAN)) is computer-based and cannot be performed in the human mind. A GAN is a class of machine learning model in which two artificial neural networks compete with each other in the form of a zero-sum game. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, visual scans of workspaces), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic printed storage code of block 200. In addition to block 200, computing environment 100 includes, for example, computer 101, wide area network (WAN) 102, end user device (EUD)103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

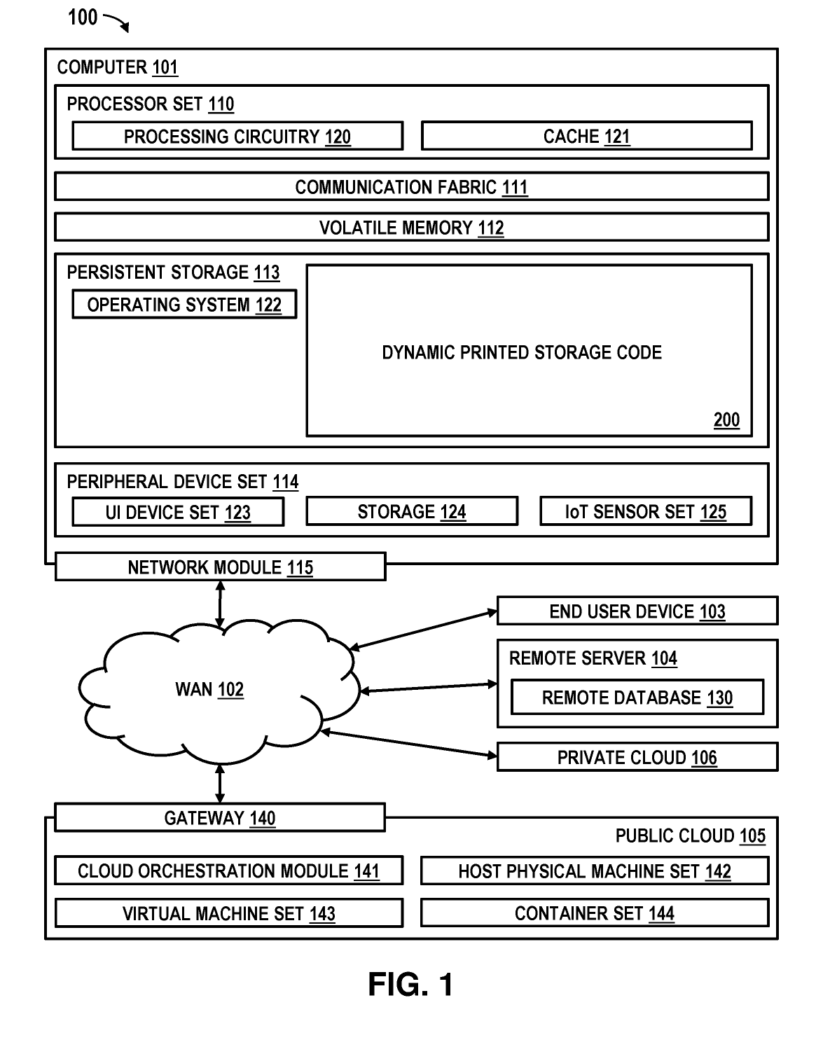

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

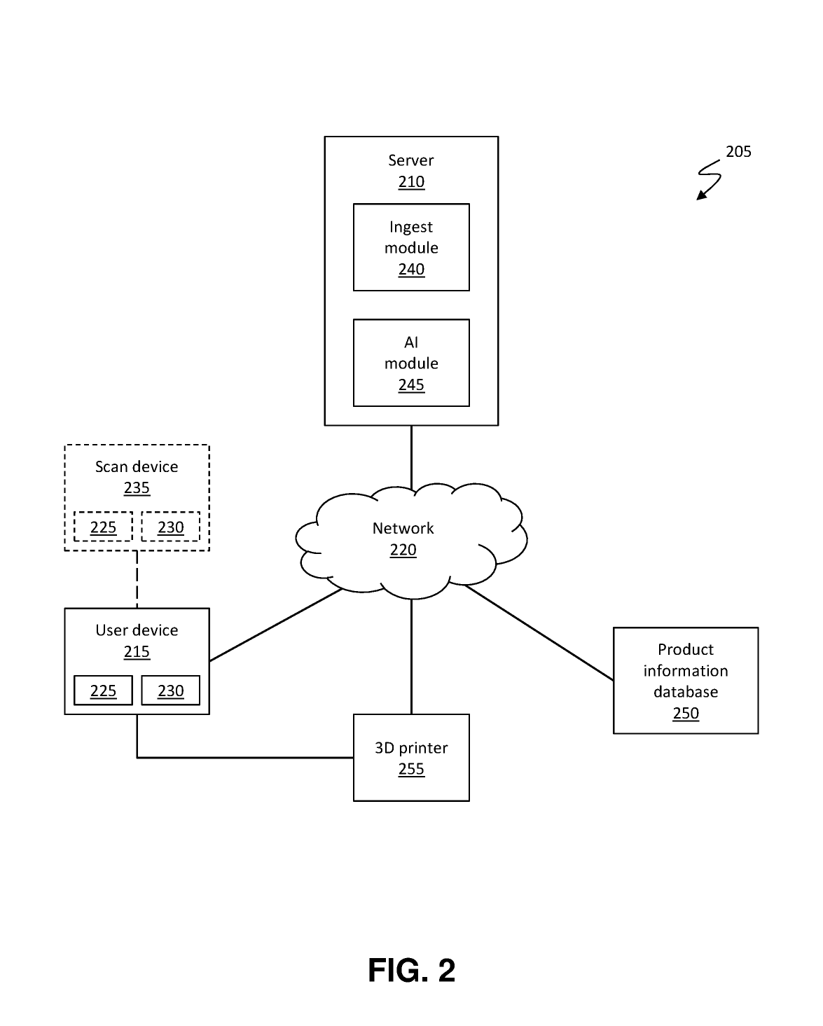

FIG. 2 shows a block diagram of an exemplary environment 205 in accordance with aspects of the invention. In embodiments, the environment 205 includes a server 210 in communication with a user device 215 via a network 220. In an exemplary configuration, the server 210 comprises one or more instances of the computer 101 of FIG. 1. In another exemplary configuration, the server 210 comprises one or more virtual machines or one or more containers running on one or more instances of the computer 101 of FIG. 1. The user device 215 may comprise an instance of the EUD 103 of FIG. 1. The network 220 may comprise one or more networks that are configured to provide communication (e.g., data communication) between computing devices, such as the WAN 102 of FIG. 1.

In accordance with aspects of the invention, the user device 215 includes or communicates with at least one camera 225 and at least one lidar (light detection and ranging) sensor 230 that are configured to perform visual scans of physical spaces in real-world environments. In a non-limiting example, the user device 215 comprises a smartphone, tablet computing device, or laptop computing device that includes the camera 225 and the lidar sensor 230. In this example, the user device 215 may be configured to function as an augmented reality (AR) device using the camera 225 and a display screen in the smartphone, tablet computing device, or laptop computing device. In another non-limiting example, the camera 225 and the lidar sensor 230 are included in a scan device 235 that is separate from the user device 215 and that communicates with the user device 215 (e.g., using wired or wireless communication). In this example, the scan device 235 may be a specialized peripheral device (e.g., such as a virtual reality (VR) headset, an AR headset, or a specialized hand-held lidar scanner) that communicates with the user device 215. The user device 215, or the scan device 235, may be programmed with specialized software that is configured to determine a 3D shape and size of a physical object or workspace based on scanning the physical object or workspace with the camera 225 and the lidar sensor 230.

In embodiments, the server 210 of FIG. 2 comprises an ingest module 240 and an AI module 245, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the ingest module 240 is configured to receive input data from the user device 215, generate specification data based on the input data, and provide the specification data to the AI module 245, which is configured to generate a 3D printable blueprint of a 3D printable storage unit based on the specification data. In embodiments, the input data includes visual scan data of a workspace and object information about an object to be stored in the workspace. As used herein, the term workspace refers to a physical space in a real-world environment in which a user intends to store the object using a 3D printed storage unit. In embodiments, visual scan data of the workspace is data that defines a 3Drepresentation of the workspace including a 3Dshape and size of the workspace and that is created based on scanning the workspace with the camera 225 and the lidar sensor 230.

In embodiments, object information comprises data that defines a 3Dshape and size of the object or data that may be used by the ingest module 240 to determine the 3D shape and size of the object. In one example, the object information comprises data that defines a 3D shape and size of the object, which may be obtained by scanning the object with the camera 225 and the lidar sensor 230, e.g., in a manner similar to scanning the workspace with the camera 225 and the lidar sensor 230. In another example, the object information comprises an identifier associated with the object that the ingest module 240 may use to determine a 3D shape and size of the object. For example, the object information may comprise a universal product code (UPC) that the ingest module 240 may use with a product information database 250 to determine the size and shape of the object. In embodiments, the product information database 250 comprises one or more instances of the remote database 130 of FIG. 1 and includes published information that defines the size and shape of various objects (such as consumer goods) associated with a unique identifier (e.g., a UPC). In this manner, the ingest module 240 may obtain data that defines a 3D size and shape of the object by accessing a database using the identifier.

In some embodiments, the object information includes additional information about the object. This additional information may include, but is not limited to, one or more selected from a group consisting of: object type (e.g., clothing, hard disk drives, etc.); object weight (e.g., a weight of the object); object flexibility (e.g., a measure of how much the object can be flexed or bent to fit within a space); object resiliency (e.g., a measure of how resilient the object is to damage or breakage); object quantity (e.g., a number or how many instances of the object are to be stored in the workspace); object orientation (a user-defined indication of an orientation of the object when the object is in the storage unit and the storage unit is in the workspace); object access (e.g., a user-defined indication of how the object can be accessed when the object is in the storage unit and the storage unit is in the workspace (e.g., via the front, top, right side, left side of the storage unit)); and object tolerance (e.g., a measure of required tolerance between the object and the storage structure). In embodiments, the additional information may be provided by a user via the user device 215, e.g., via a graphical user interface (GUI) or conversational user interface (CUI) associated with the user device 215.

In some embodiments, the input data further includes demarcation information in addition to the visual scan data and the object information. In embodiments, the demarcation information includes information provided by the user that defines one or more user-defined spatial constraints associated with the workspace associated with the visual scan data. The demarcation information may be received via a GUI and/or CUI associated with the user device 215. For example, while scanning the workspace with the camera 225 and the lidar sensor 230, the user device 215 may present an AR interface (e.g., a GUI) showing the workspace in the physical environment, and the user may provide input via the AR interface to identify a structure in the physical environment and natural language input via the CUI defining a spatial constraint of the workspace relative to the identified structure. For example, while scanning the workspace with the user device 215, the user may make a touch screen input to the AR interface to identify a structure, and the user may make a natural language utterance (e.g., such as “leave a half-inch clearance from the selected structure”). In embodiments, the demarcation information includes data identifying the selected structure in the visual scan and the natural language utterance associated with the selected structure, and the user device 215 provides this demarcation information to the ingest module 240 as part of the input data. The demarcation information may include multiple inputs from the user (e.g., “leave a half-inch clearance around the left, right, top, and bottom, and make the front edge flush with the selected structure”). These examples are not limiting, and other techniques may be used to obtain demarcation information may be obtained from the user.

In accordance with aspects of the invention, the ingest module 240 is configured to generate specification data based on the input data. In embodiments, the ingest module 240 analyzes the demarcation information (e.g., using natural language processing) to determine one or more user-defined spatial constraints associated with the workspace. In embodiments, the ingest module 240 generates specification data that includes the 3D shape and size of the workspace, the 3D shape and size of the object, the additional information about the object (if any), and the user-defined spatial constraints (if any), and the ingest module 240 provides this specification data to the AI module 245. In embodiments, the additional information about the object may be in the form of metadata associated with the specification data.

In accordance with aspects of the invention, the AI module 245 is configured to generate a 3D printable blueprint of a 3D printable storage unit based on the specification data. In embodiments, the AI module 245 comprises a trained generative adversarial network (GAN), which is a class of machine learning model in which two artificial neural networks compete with each other in the form of a zero-sum game. In embodiments, the GAN receives the specification data as input and generates, based on this input, a 3D printable blueprint of a 3D printable storage unit that is customized to fit within the workspace and that is customized to hold the object. As used herein, a 3D printable blueprint is a digital representation of a three-dimensional structure that serves as instructions for building a physical copy of the structure using additive manufacturing. In one example, the 3D printable blueprint comprises a CAD (computer-aided design) file, such as an “STL” file, for example, that may be used by a 3D printer to 3D print a physical copy of the structure.

In various embodiments, the GAN of the AI module 245 generates one or more 3D models that define the storage unit based on the 3D shape and size of the workspace, the 3D shape and size of the object, the additional information about the object (if any), and the user-defined spatial constraints (if any). By the GAN taking into account the additional information about the object (if any) and the user-defined spatial constraints (if any), the 3D model of the storage unit may be customized not only for the size and shape of the workspace and the size and shape of the object, but also according to the user-defined demarcation and additional characteristics of the object. For example, a storage unit defined by the 3D model generated by the GAN not only fits within the workspace, but fits within the workspace in a manner that conforms to any demarcations provided by the user, and is also sized and shaped to hold the object in a manner that conforms to any user-defined one or more of object type, object flexibility, object resiliency, object quantity, object orientation, and object access. In this manner, the GAN may be configured to determine an optimal placement of the object within the storage unit and to generate the 3D model of the storage unit based on this determined optimal placement. In embodiments, if the user does not specify an orientation of the object with the storage unit, the GAN may determine an orientation of the object with the storage unit that is optimized to satisfy other constraints of the storage unit.

In embodiments, the AI module 245 may be configured to recommend a dimension, shape, size, and location of the storage unit in the workspace. For example, the GAN of the AI module 245 may be trained to make suggestions to move or relocate other items in the workspace (as shown in the visual scan) to optimize the design of the storage unit. The suggestion may be communicated to the user via an output of the device 215 (e.g. “move the bookcase over 1 foot to optimize the size of the storage unit to fit more objects and efficiently print”).

In embodiments, the AI module 245 provides the 3D printable blueprint of a 3D printable storage unit to the user device 215. The user may then utilize a 3D printer 255 to 3D print the storage unit by providing the 3D printable blueprint to the 3D printer (e.g., via the user device 215). In some embodiments, the 3D printable blueprint includes multiple 3D models that define multiple structures that the user may print individually using the 3D printer 255 and then assemble with one another to form the storage unit.

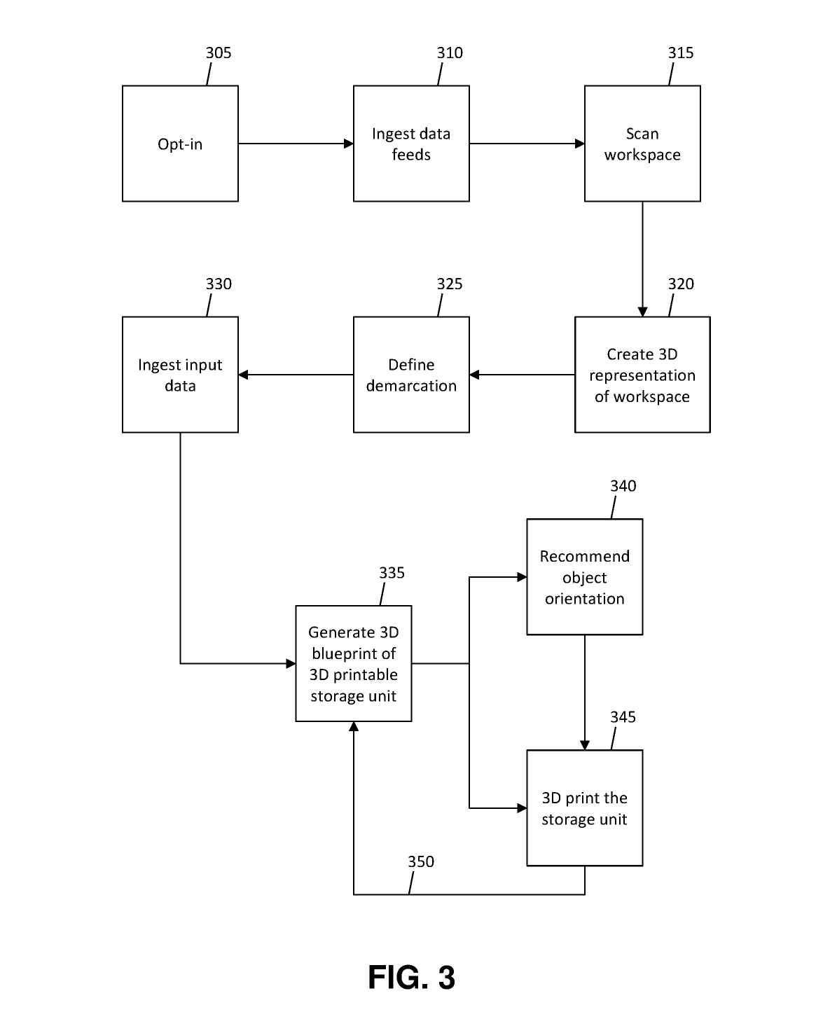

FIG. 3 shows a flowchart of an exemplary method in accordance with aspects of the present invention. Steps of the method (also referred to as operations) may be carried out in the environment of FIG. 2 and are described with reference to elements depicted in FIG. 2.

At step 305 the system (e.g., the server 110) receives an opt-in from a user, e.g., via the user device 215. The opt-in may include user authorization for the system to utilize input data provided by the user. At step 310 the system ingests various data feeds including but not limited to one or more data feeds from one or more product information databases 250 and one or more data feeds from one or more Internet of Things (IoT) devices. In some embodiments, the AI module 245 runs in one or more computing devices that are separate from the server 208, and in these embodiments the data feeds may include a data feed to the AI module 245.

At step 315 the user scans the workspace that is intended for the storage unit using the camera 225 and lidar sensor 330, e.g., as described with respect to FIG. 2. At step 320 software associated with the camera 225 and lidar sensor 330 creates a 3D representation of the workspace (e.g., data defining the 3D size and shape of the workspace) based on the scan data from step 315. At step 325, the user provides input defining one or more demarcations associated with the workspace, e.g., as described with respect to FIG. 2.

At step 330 the system ingests the input data. In embodiments, step 330 comprises the ingest module 240 receiving the input data from the user device 215. As described with respect to FIG. 2, the input data may include the visual scan data (e.g., the 3D representation of the workspace), the object information, and demarcation information. At step 335, the system generates a 3D blueprint of the 3D printable storage unit based on the input data. As described with respect to FIG. 2, the ingest module 240 may create specification data based on the input data and provide the specification data to the AI module 245, which may include a trained GAN that generates the 3D blueprint based on the specification data. Optionally at step 340 the system recommends an orientation of the object in the storage unit, e.g., as described with respect to FIG. 2. Following step 335 or 340, the storage unit is printed at step 345 using a 3D printer 255 and the 3D blueprint. In some embodiments, the user causes the 3D printing by interacting with the 3D printer 255. In other embodiments, the server 208 causes the 3Dprinting by interacting with the 3D printer 255 without user input.

In some embodiments, following 3D printing of the storage unit at step 345 and as indicated by arrow 350, the system receives feedback and reevaluates the 3D blueprint of the 3D printable storage unit based on the feedback. For example, the user may re-scan the workspace (e.g., with the camera 235 and lidar sensor 240) with the printed storage unit in the workspace, and the AI module 245 may generate a revised 3D blueprint of the 3D printable storage unit based on a combination of the initial input data and the new data from the re-scanning. In another example, the user may revise the object information and/or add more object information, and the AI module 245 may generate a revised 3D blueprint of the 3D printable storage unit based on a combination of the initial input data and the revised and/or added object information. In this manner the AI module 245 may revalidate the efficiency and the effectiveness of the 3D printable storage unit based on a combination of the initial input data and the feedback.

Exemplary and non-limiting use cases that illustrate aspects of the present disclosure will now be described. In a first of the use cases, a first user is a small business owner and is looking to improve the organization and efficiency of their storage spaces in their business location. The first user currently has a cluttered storage room that they would like to optimize for inventory of products. The first user decides to use an exemplary implementation of the invention to generate a 3D printable blueprint of a storage unit that is customized to fit the space and their intended goods. In this use case, the first user scans a workspace in the storage room and also provides object information including the weight, size, and quantity of products (e.g., objects) to be stored in one or more storage units in the workspace. In this use case, the server 208 receives this input data from the first user and generates a 3D blueprint of a unique storage unit that is tailored to the specific needs of the first user. The first user then 3D prints the storage unit and utilize the storage unit to organize and store their inventory in the workspace, resulting in a more efficient and organized storage space.

In a second one of the user cases, a large retail company is looking to improve the organization and efficiency of their warehouse storage spaces. They currently have a large warehouse with a lot of unused space and a cluttered storage area that is difficult to navigate. They decide to use an exemplary implementation of the invention to generate a 3D printable blueprint of a storage unit that is customized to fit the space and their intended goods. By providing information about the weight, size, and quantity of their products, the AI module 245 is able to generate a unique storage unit that is tailored to their specific needs. The retail company is able to 3D print the storage unit and use it to organize and store their inventory, resulting in a more efficient and organized warehouse storage space.

It is understood from the present disclosure that exemplary implementations of the invention may be used to ingest a video feed of a workspace to dynamically generate a form factor storage unit to fit the workspace and intended goods. The system may ingest data defining a workspace as marked by a visual scan, ingest the desired storage goods, and generate a relevant unique 3D printable blueprint. The visual scan may be aided by a user’s manual demarcation. The system may ingest metadata surrounding the weight, resilience, and tolerance of goods to be placed inside the storage unit. The system may advise the user about storage capacity related to the workspace or visual detection or recommendation of efficient space usage and selection. In this manner, implementations may be configured to take into account the weight, resilience, and tolerance of the goods to be placed inside the storage unit, advise on the capacity of storage related to the workspace, and provide recommendations for efficient space usage and selection.

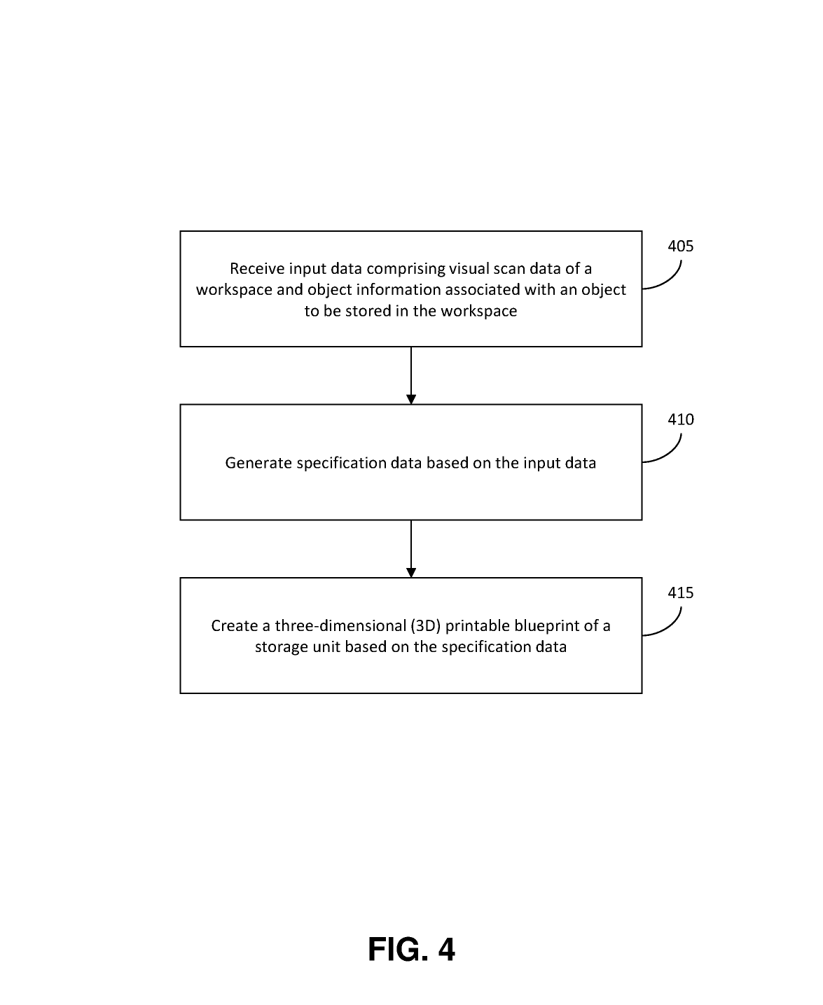

FIG. 4 shows a flowchart of an exemplary method in accordance with aspects of the present invention. Steps of the method (also referred to as operations) may be carried out in the environment of FIG. 2 and are described with reference to elements depicted in FIG. 2.

At step 405 the system receives input data comprising visual scan data of a workspace and object information associated with an object to be stored in the workspace. In embodiments and as described with respect to FIG. 2, the ingest module 240 may receive the input data from the user device 215.

At step 410 the system generates specification data based on the input data. In embodiments and as described with respect to FIG. 2, the ingest module 240 may generate the specification data based on the input data.

At step 415, the system creates a three-dimensional (3D) printable blueprint of a storage unit based on the specification data. In embodiments and as described with respect to FIG. 2, the AI module 245 may generate the 3D printable blueprint based on the specification data.

In embodiments of the method of FIG. 4., the 3D printable blueprint is usable by a 3D printer to manufacture the storage unit using additive manufacturing.

In embodiments of the method of FIG. 4, the storage unit is customized to fit within the workspace and to hold the object.

In embodiments of the method of FIG. 4, the visual scan data comprises data that defines a 3D size and shape of the workspace.

In embodiments of the method of FIG. 4, the visual scan data is obtained using a camera and a lidar sensor.

In embodiments of the method of FIG. 4, the object information comprises data that defines a 3D size and shape of the object.

In embodiments of the method of FIG. 4, the object information comprises an identifier associated with the object, and further comprising obtaining data that defines a 3D size and shape of the object by accessing a database using the identifier.

In embodiments of the method of FIG. 4, the object information comprises additional information associated with the object, the additional information including one or more selected from a group consisting of: object type; object weight; object flexibility; object resiliency; object quantity; object orientation; object access; and object tolerance.

In embodiments of the method of FIG. 4, the input data further comprises demarcation information. The demarcation information may include information that defines one or more user-defined spatial constraints associated with the workspace.

In embodiments of the method of FIG. 4, the creating a 3D printable blueprint comprises: an artificial intelligence (AI) model receiving the specification data as an input; and the AI model generating the 3D printable blueprint as an output based on the specification data as the input. The AI model may comprise a trained generative adversarial network.

In embodiments of the method of FIG. 4, the method further comprises: recommending an orientation of the object in the storage unit; and recommending a relocation of the object to optimize a size of the storage unit.

In embodiments of the method of FIG. 4, the method further comprises: receiving feedback associated with the storage unit; and reevaluating the 3D blueprint based on the feedback. The feedback may comprise a visual scan of the storage unit in the workspace.

In embodiments of the method of FIG. 4, the method further comprises manufacturing the storage unit using the 3D blueprint with a 3D printer.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving input data comprising visual scan data of a workspace and object information associated with an object to be stored in the workspace;
generating specification data based on the input data; and
creating a three-dimensional (3D) printable blueprint of a storage unit based on the specification data.

2. The method of claim 1, wherein the 3D printable blueprint is usable by a 3D printer to manufacture the storage unit using additive manufacturing.

3. The method of claim 1, wherein the storage unit is customized to fit within the workspace and to hold the object.

4. The method of claim 1, wherein the visual scan data comprises data that defines a 3D size and shape of the workspace.

5. The method of claim 1, wherein the visual scan data is obtained using a camera and a lidar sensor.

6. The method of claim 1, wherein the object information comprises data that defines a 3D size and shape of the object.

7. The method of claim 1, wherein the object information comprises an identifier associated with the object, and further comprising obtaining data that defines a 3D size and shape of the object by accessing a database using the identifier.

8. The method of claim 1, wherein the object information comprises additional information associated with the object, the additional information including one or more selected from a group consisting of: object type; object weight; object flexibility; object resiliency; object quantity; object orientation; object access; and object tolerance.

9. The method of claim 1, wherein the input data further comprises demarcation information.

10. The method of claim 9, wherein the demarcation information includes information that defines one or more user-defined spatial constraints associated with the workspace.

11. The method of claim 1, wherein the creating a 3D printable blueprint comprises:
an artificial intelligence (AI) model receiving the specification data as an input; and
the AI model generating the 3D printable blueprint as an output based on the specification data as the input.

12. The method of claim 11, wherein the AI model comprises a trained generative adversarial network.

13. The method of claim 1, further comprising:
recommending an orientation of the object in the storage unit; and
recommending a relocation of the object to optimize a size of the storage unit.

14. The method of claim 1, further comprising:
receiving feedback associated with the storage unit; and
reevaluating the 3D blueprint based on the feedback.

15. The method of claim 14, wherein the feedback comprises a visual scan of the storage unit in the workspace.

16. The method of claim 1, further comprising manufacturing the storage unit using the 3D blueprint with a 3D printer.

17. A computer program product comprising:
one or more computer-readable storage media; and
program instructions stored on the one or more computer-readable storage media to perform operations comprising:
receiving input data comprising visual scan data of a workspace and object information associated with an object to be stored in the workspace;
generating specification data based on the input data; and
creating a three-dimensional (3D) printable blueprint of a storage unit based on the specification data, wherein the 3D printable blueprint comprises a digital representation of the storage unit that is usable by a 3D printer to manufacture the storage unit using additive manufacturing.

18. The computer program product of claim 17, wherein the storage unit is customized to fit within the workspace and to hold the object.

19. A computer system comprising:
a processor set;
one or more computer-readable storage media; and
program instructions stored on the one or more computer-readable storage media to cause the processor set to perform operations comprising:
receiving input data comprising visual scan data of a workspace and object information associated with an object to be stored in the workspace;
generating specification data based on the input data; and
creating a three-dimensional (3D) printable blueprint of a storage unit based on the specification data, wherein the 3D printable blueprint comprises a digital representation of the storage unit that is usable by a 3D printer to manufacture the storage unit using additive manufacturing, and wherein the storage unit is customized to fit within the workspace and to hold the object.

20. The computer system of claim 19, wherein the operations further comprise one of:
manufacturing the storage unit using the 3D blueprint with a 3D printer; or
transmitting the 3D blueprint to a user device such that the user of the user device may utilize the 3D blueprint to manufacture the storage unit using the 3D blueprint with the 3D printer.
